(19) United States
(12) Patent Application Publication
(10) Pub. No.: US 2011/0116441 A1
(43) Pub. Date: May 19, 2011

(54) SYSTEMS AND METHODS FOR SATELLITE COMMUNICATION

(75) Inventor: Gregory Thane Wyler, Sewalls Point, FL (US)

(73) Assignee: O3B Limited, St. John (JE)

(21) Appl. No.: 12/938,760

(22) Filed: Nov. 3, 2010

Related U.S. Application Data
(63) Continuation of application No. PCT/US08/63853, filed on May 16, 2008.

(51) Int. Cl. H04B 7/185

(52) U.S. Cl. 370/316

(57) ABSTRACT

A system and method are disclosed which may include a plurality of ground stations operable to transmit and receive analog signal energy; at least one satellite in orbit around the earth and in communication with at least two ground stations, wherein the satellite comprises: a plurality of transponders, wherein at least two transponders are configured to communicate with at least two different transceiver stations; at least one routing mechanism for routing each analog data packet signal received at the satellite to a selected one of said at least two transponders based on a transmission frequency of each said analog data packet signal.

### RELATED APPLICATIONS

This application is a continuation of PCT application Serial No. PCT/US08/063,853, filed May 16, 2008, entitled “SYSTEMS AND METHODS FOR SATELLITE COMMUNICATION” [Attorney Docket 790-4-PCT], published as Pub. No. WO 2009/139778 on Nov. 19, 2009, the disclosure of which is incorporated by reference herein in its entirety.

### BACKGROUND OF THE INVENTION

The present invention relates in general to communication systems and in particular to systems and methods for satellite based communication.

Satellite communication systems provide various benefits to consumers of communication services such as for telephony, internet communications, television communications among others. Various satellite systems are currently available, which employ a wide variety of communication options.

For instance, satellite communication systems provide a range of choices for routing signals that originate at earth-based customer terminals, get transmitted to satellites, and are then rebroadcast to other customer terminals. One option for directing signal traffic onboard a satellite is “bent-pipe” technology.

Bent pipe architecture is commonly employed in the satellite industry. The term “bent pipe” refers to a communication apparatus configured for re-broadcasting a signal without demodulating the signal. Thus, when employing this approach, the entire satellite communications path remains in the analog domain.

One benefit of the bent-pipe approach is simplicity. Using the bent-pipe approach, the same signal that is transmitted to the satellite is retransmitted back to an earth-based customer terminal. Retransmitting communication signals in this manner may be accomplished with simple circuits having a small number of electronic components, which increases reliability and reduces costs. Moreover, the reliability of the bent-pipe designs is enhanced by the fact that the circuits and circuit components used in such designs operate in a well understood manner and have established track records of successful operation dating back many years.

However, one drawback of this approach is that the bent-pipe design can be inefficient at delivering data for Internet communication. This is because Internet data traffic is composed of many individual packets each having their own destination addresses. A bent-pipe communication apparatus has no means of reading the destination of a packet and thus has no decision-making capability regarding the routing of the packet.

Thus, determining the destination of a data packet requires that the analog data of the packet be “demodulated” into logical 1 values and logical 0 values, which demodulation is not performed by bent-pipe communication apparatus. Thus, when using bent-pipe communication equipment, all communication data are transmitted to a destination on the Earth dictated by the configuration of the bent-pipe satellite communication apparatus. Thereafter, the transmitted data packets are demodulated at the destination location. The IP (Internet Protocol) addresses of each packet may then be determined using the demodulated data, thereby enabling the packets to be suitably re-routed to their respective destinations.

The packets are then transmitted from a ground terminal to one or more selected satellites to enable delivering the packets their respective destinations. This process may require a “double hop” over the satellite. Specifically, the data communication path may extend from a source to a satellite, then to a modem on the ground, then back to a selected satellite, and finally to the destination address.

The described communication trajectory can effectively double the communication latency (total round trip time from source to destination and back again). For instance, when using a Geo-Synchronous (GEO) satellite, one full second or more may be needed for data to complete a single round trip data path.

An additional drawback associated with the bent pipe design is that the transponders on a satellite are dedicated to transmitting along a particular path. This arrangement may be inefficient when only a portion of a transponder's bandwidth is needed for a given communication path. For example, a typical GEO satellite may have 50 transponders, with each transponder having a communication bandwidth of, for example, 36 MHz (Megahertz). The transponders can be “pointed” in any direction, including for instance to footprints on the Earth that are North, South, East, or West of a given satellite's location. Specifically, first and second groups of transponders on a given satellite could be arranged to conduct communication with two respective locations on the earth's surface.

A satellite operator can then sell links between physical locations. For example, a North-South bent-pipe satellite setup would involve using one transponder to provide a communication link between the satellite and a location on the Earth's surface to the south of the satellite. Another transponder on the satellite could be configured to provide a second communication link between the satellite and a location on the Earth's surface to the north of the satellite. An example is considered in which the northern and southern locations correspond to Europe and southern Africa, respectively. Thus, in this case, the full bandwidth of two transponders will be employed for communication between these two specific locations.

Using the above-described configuration, where only a portion of the bandwidth of a transponder is needed (such as, for instance, 20 MHz), the unused transponder bandwidth is useable only by a customer requiring communication bandwidth between the two locations served by the satellite in question. This may lead to bandwidth either being wasted, or to being used inefficiently.

A case is considered in which a South African bank central office seeks communication with various branch offices located in various locations in southern Africa, where the various locations lack land-based communication links to the central office. In this situation, the central office needs a satellite communication link coupling different regions within southern Africa together. This coupling could be provided by a satellite having bent-pipe communication apparatus with different transponders having communication links with different respective locations within southern Africa, which may be referred to herein as “south-south” links. In a case such as this, the total communication bandwidth required by the bank may correspond to less than the bandwidth of a single transponder. However, dedicating an entire transponder in this manner to an application that needs only a portion of the transponder's bandwidth is a costly and wasteful practice.

Moreover, in many cases, only north-south links are available. In this context, “north-south links” refer to satellites having bent-pipe communication apparatus including a first group of one or more transponders in communication with one or more northern locations, and a second group of one or more transponders in communication with one or more southern locations. Thus, where only north-south links are available, the bank central office will generally communicate with its branch office by having its data transmitted from Africa to the satellite, then to a ground location in Europe, where the data packets will be demodulated. The data will then be sent back to the satellite, and from there be directed to the branch offices. However, as discussed earlier, this double-hop communication path produces considerable communication latency. Moreover, such a path also uses up valuable bandwidth on satellites configured to provide north-south links.

### On-Board Processing

A well known alternative to a using bent-pipe communication apparatus, is to use an “onboard processor” on the satellite. Onboard processing gives the satellite the ability to read destination data for each packet and route the packets accordingly. If confronted with the fact pattern discussed above, the satellite could be configured to have one transponder for each of the North South, East, and West directions. Upon receiving communication data, the satellite demodulates each packet, reads the destination information, and then suitably routes the packet to its destination based on the destination information. In this case, the onboard routing is able to direct the packet directly to its destination, and is therefore able to avoid the inefficiency incurred by the “double hop” discussed above in connection with the bent-pipe satellite configuration. Thus, onboard processing is effective at efficiently using bandwidth and transponder capacity. Effectively, the onboard processor configuration provides a “router in the sky”.

However, onboard processing incurs disadvantages in the areas of cost, reliability, and obsolescence, as discussed in the following. Onboard processors for routing data use space-hardened semi-conductor devices which require expensive, customized engineering. Moreover, operating the onboard processors requires a significant amount of additional power. The components needed to provide this additional power add significant weight and cost to the satellite in the form of additional solar panels and batteries, among other devices.

The reliability of onboard processors is difficult to predict due to the relatively short history of such devices aboard satellites. Onboard processing requires semiconductor devices which undergo relatively rapid technological change. Accordingly, it is intrinsically difficult to provide devices which are both fully up to date technologically and which also have a proven track record.

A typical satellite lifetime is between ten and fifteen years. Thus, during the life of the satellite, the available digital processing technology will have changed dramatically, and after the first few years the technical features of the satellite's onboard processing system will have become outdated.

Accordingly, there is a need in the art for a satellite communication system that provides communication bandwidth efficiency both reliably and at a reasonable cost.

### SUMMARY OF THE INVENTION

According to one aspect, the invention provides a communication system that may include a plurality of ground stations operable to transmit and receive analog signal energy; at least one satellite in orbit around the earth and in communication with at least two ground stations, wherein the satellite may include a plurality of transponders, wherein at least two transponders are configured to communicate with at least two different communication devices; at least one routing mechanism for routing an analog data packet signal received at the satellite to a selected one of the at least two transponders based on a transmission frequency of each analog data packet signal. Preferably, a transmission path of the analog data packet signal through the satellite includes only analog equipment. Preferably, the routing mechanism comprises at least one frequency divider. Preferably, the routing mechanism is operable to select from a) a first transponder broadcasting toward a footprint on the earth in proximity to a current location of the satellite; and b) a second transponder configured to communicate with a gateway station, for rebroadcast of analog data packet signals routed by the routing mechanism. Preferably, the first transponder broadcasting toward the proximate footprint is operable to provide intra-region backhaul between transceiving devices within the footprint not having land-based, wired connections disposed therebetween.

The system may further include a computing system in communication with at least one ground station, the computing system having a memory for storing a data table containing a plurality of IP addresses and a respective plurality of transmission frequencies corresponding to the IP addresses. Preferably, the computing system is operable to read IP (Internet Protocol) addresses of digital data packets received at the ground station. Preferably, the computing system is operable to retrieve a transmission frequency corresponding to the IP address of each received digital data packet. Preferably, the at least one ground station comprises a modem for converting the received digital data packets into respective analog data packet signals. Preferably, each communication device is one of: a) a ground station capable of both receiving and transmitting data; b) a satellite capable of both receiving and transmitting data; and c) a receiver.

According to another aspect, the invention provides a method for sending data within a satellite communications system that may include receiving a digital data packet at a first ground station within the communications system; converting the digital data packet into an analog signal; establishing a magnitude of a selected physical characteristic of the analog packet signal as a function of a destination of the digital data packet; transmitting the analog packet signal from the first ground station to a first satellite; routing the analog packet signal to a given transponder aboard the first satellite based on the magnitude of the selected physical characteristic of the analog packet signal; and transmitting the analog packet signal from the given transponder to a transceiver station.

Preferably, the transceiver station is one of: a) a second satellite; and b) a ground station having a land-based connection with the digital data packet destination. Preferably, the physical characteristic is selected from the group consisting of: transmission frequency; amplitude; and signal shape. The method may further include identifying a destination Internet Protocol (IP) address of the digital data packet; and wherein the establishing step comprises: establishing a transmission frequency for the analog packet signal based on the IP address of the digital data packet. Preferably, the step of transmitting the analog packet signal to the satellite comprises: transmitting the analog packet signal using the established transmission frequency.

The method may further include performing the step of routing the analog packet signal aboard the satellite using only analog equipment. The method may further include performing the step of routing the analog packet signal aboard the satellite without demodulating the analog packet signal. The method may further include performing the step of routing the analog packet signal using at least one frequency divider. Preferably, the step of transmitting the analog packet signal to the destination of the digital data packet includes comprises one of: transmitting the analog packet signal to a gateway station; and transmitting the analog packet signal out of a satellite transponder toward a region on the earth including the first ground station, to effect intra-region backhaul.

According to yet another aspect, the method may include providing at least one satellite; receiving a signal at the satellite from a customer site; determining a transmission frequency of the customer signal; routing the customer signal to an output port of a transponder selected according to the determined transmission frequency; and retransmitting the customer signal from the selected transponder. The method may further include prior to sending the signal to the satellite, determining a destination IP (Internet Protocol) address for the signal; and assigning a transmission frequency to the signal based on the determined destination IP address. Preferably, the routing step comprises: deploying a frequency divider having an input and a plurality of outputs, wherein the frequency divider is operable to direct signals within a plurality of frequency ranges along a plurality of respective signal routing paths within the satellite. The method may further include configuring the frequency divider to associate a plurality of transmission frequency ranges with a plurality of signal routing paths emerging from the frequency divider. The method may further include coordinating the association of the transmission frequency ranges with the signal routing paths of the frequency divider with a corresponding association of frequency ranges to data transmission destinations resident within a ground station transmission system.

According to another aspect, the method may include receiving a data packet at a ground station within a satellite communication system, the data packet including a destination IP (Internet Protocol) address; identifying the destination IP address of the data packet; selecting a transmission frequency channel for the data packet based on the IP address of the data packet;

transmitting the data packet to a satellite, of the satellite communication system, using the selected transmission frequency. The method may further include assigning a plurality of transmission frequencies to a plurality of respective transmission destinations. The method may further include modulating the data packet to provide an analog signal indicative of the data packet, prior to the transmitting step. The method may further include selecting a sub-channel, of the selected channel, for transmission of the data packet based on at least one of: a) an identification of the ground station from which the data packet is being transmitted; and b) an identification of a customer site from which the data packet originated. The method may further include receiving the data packet at the satellite; routing the data packet within the satellite in accordance with the transmission frequency of the data packet; and transmitting the data packet to a destination transceiver station within the satellite communication system. Preferably, the transceiver station is either a satellite or a ground station.

Other aspects, features, advantages, etc. will become apparent to one skilled in the art when the description of the preferred embodiments of the invention herein is taken in conjunction with the accompanying drawings.

### BRIEF DESCRIPTION OF THE DRAWINGS

For the purposes of illustrating the various aspects of the invention, the drawings illustrate some forms that are presently preferred, it being understood, however, that the invention is not limited to the precise arrangements and instrumentalities shown in the drawings.

FIG. 1 is a block diagram of a communication system 100 including a satellite system in accordance with one or more embodiments of the present invention;

FIG. 2 is a block diagram of a portion of a communication system in accordance with one or more embodiments of the present invention;

FIG. 2A is a block diagram of a portion of computing system that may be deployed in communication with at least one ground station of the system of FIG. 2;

FIG. 2B is a block diagram of a communication system in accordance with an embodiment of the present invention;

FIG. 3 is a block diagram of the electrical hardware aboard a satellite in accordance with one or more embodiments of the present invention;

FIG. 4A is a flow diagram of a series of steps that may be performed to configure a modem and ground station for transmitting and/or receiving data in accordance with one or more embodiments of the present invention;

FIG. 4B is a flow diagram of a series of steps that may be performed to configure communication equipment on a satellite for receiving and/or transmitting data in accordance with one or more embodiments of the present invention;

FIG. 5 is block diagram showing the location and condition of an exemplary data packet transmitted through a communication system in accordance with one or more embodiments of the present invention;

FIG. 6 is a flow diagram of a method for routing a data packet through a communication system in accordance with one or more embodiments of the present invention;

FIG. 7 is a block diagram showing a plurality of transponders on a satellite in accordance with one or more embodiments of the present invention;

FIG. 8 is a block diagram showing at least a portion of the signal routing apparatus on a satellite configured in accordance with one or more embodiments of the present invention;

FIG. 9 is a block diagram showing a modified version of the signal routing apparatus of FIG. 8;

FIG. 10 is a schematic diagram of a satellite in communication with its broadcast region on the Earth, in accordance with one or more embodiments of the present invention; and

FIG. 11 is a block diagram of a computer system adaptable for use with one or more embodiments of the present invention.

### DETAILED DESCRIPTION OF THE PREFERRED EMBODIMENTS

In the following description, for purposes of explanation, specific numbers, materials and configurations are set forth in order to provide a thorough understanding of the invention. It will be apparent, however, to one having ordinary skill in the art that the invention may be practiced without these specific details. In some instances, well-known features may be omitted or simplified so as not to obscure the present invention. Furthermore, reference in the specification to phrases such as “one embodiment” or “an embodiment” means that a particular feature, structure or characteristic described in connection with the embodiment is included in at least one embodiment of the invention. The appearances of phrases such as “in one embodiment” or “in an embodiment” in various places in the specification do not necessarily all refer to the same embodiment.

Those skilled in the art will appreciate the fact that antennas, which may include beamformers, and/or may include equipment for communicating over optical links which communicate either with other satellites or with ground stations, are reciprocal transducers which exhibit similar properties in both transmission and reception modes. For example, the antenna patterns for both transmission and reception are generally identical and may exhibit approximately the same gain. For convenience of explanation, descriptions are often made in terms of either transmission or reception of signals, on the understanding that the pertinent description applies to the other of the two possible operations. Thus, it is to be understood that the antennas of the different embodiments described herein may pertain to either a transmission or reception mode of operation. Those of skill in the art will also appreciate the fact that the frequencies received and/or transmitted may be varied up or down in accordance with the intended application of the system.

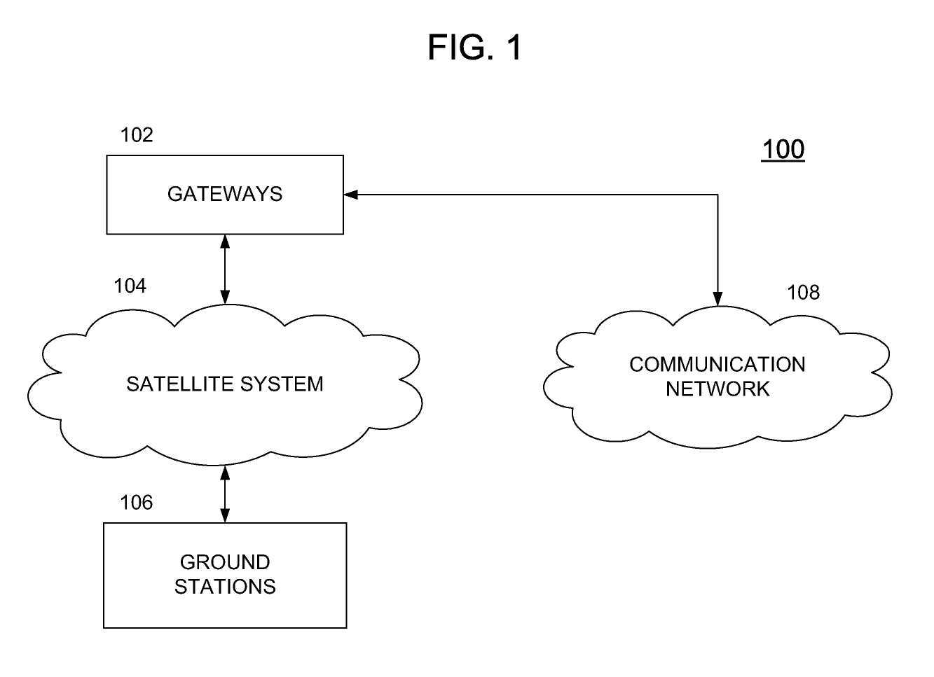

FIG. 1 is a block diagram of a communication system 100 including a satellite system 104 in accordance with one or more embodiments of the present invention. Communication system 100 may include ground stations 106, satellite system 104, communication gateways 102, and communication network 108. The portions of system 100 identified above are described further below.

Communication network 108 may be a ground based network that may include the Internet. However, communication network 108 may refer to any communications network or system capable of employing a satellite communications system to enable communication between one or more ground stations 106 with a network 108 and/or with each other. Such systems may include, either in place of or in addition to the Internet, telephone systems (landline and/or wireless), radio communications (one-way broadcast and/or two-way radio), television broadcasting, international warning system broadcast (such as for weather emergencies or other event), and/or other communication systems.

Gateways 102 may serve as communication intermediaries between one or more satellites and one or more ground-based communication networks. Herein, gateways 102 may serve as interfaces between communication network 108 and satellite system 104. Gateways 102 may include one or more gateway stations or gateway terminals for receiving/transmitting data for retransmission to satellite system 104 and/or communication network 108. Gateway stations 102 could be land-based and may provide any needed data communication routing and/or data format conversion needed to enable communication between communication network 108 and satellite system 104. For instance, gateway stations 102 may include controllers and/or other control means for controlling the location of a data communication path, such as by selecting one or more satellites from among a plurality of satellites to conduct data communication with and/or selecting one or more transponders on one satellite or distributed over a plurality of satellites for conducting data communication. In some respects, a gateway station 102 may be considered to be a special-purpose ground station. However, in other embodiments, one or more gateways 102 may be satellites serving as intermediary transceiving stations a) between a satellite and a ground station; b) between two satellites; and/or c) between two ground stations.

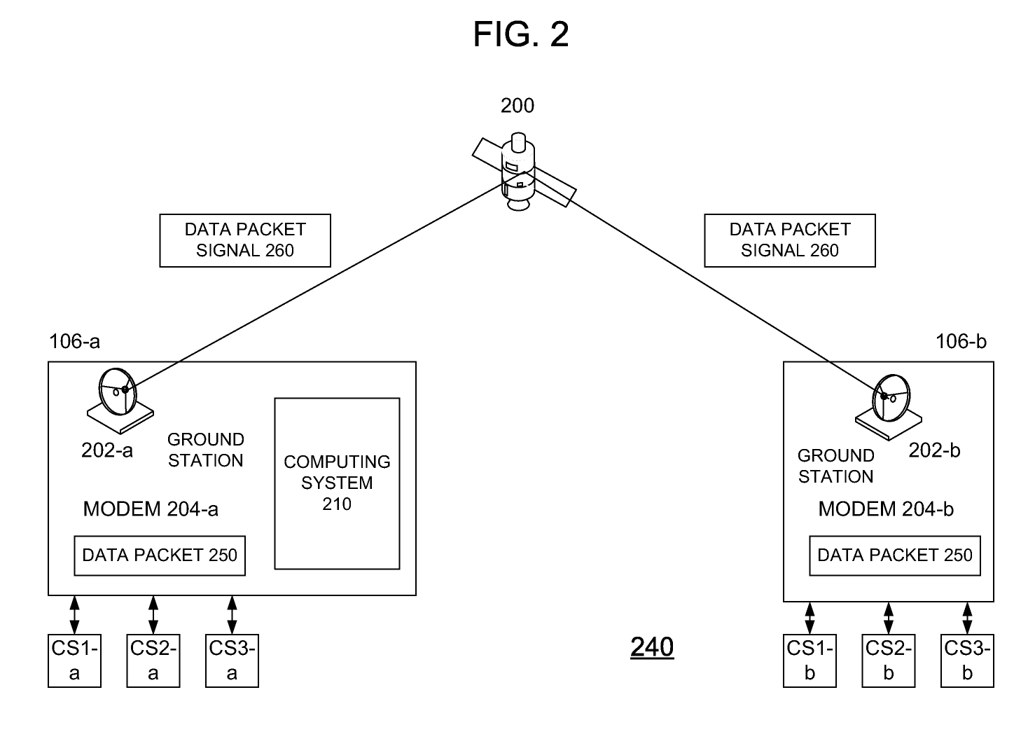

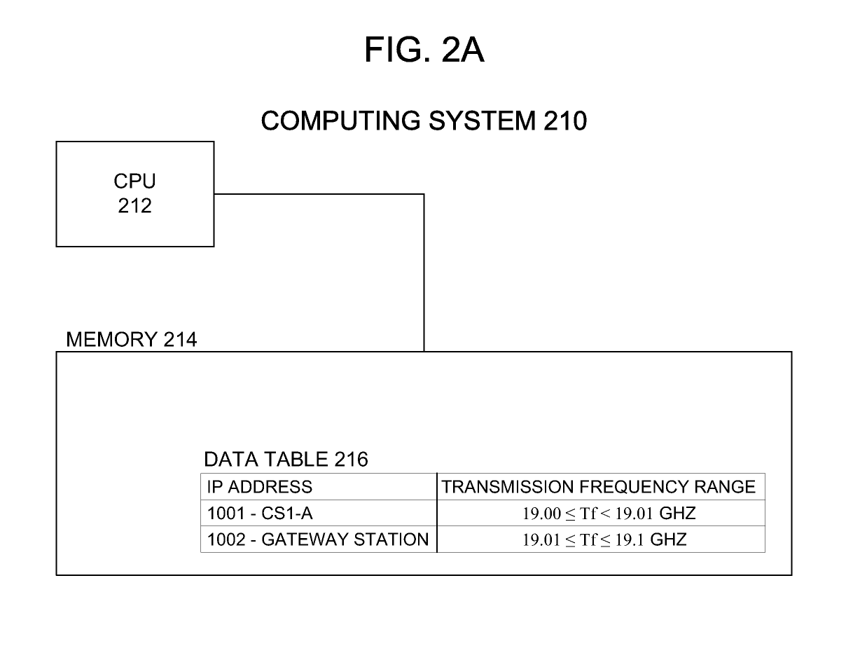

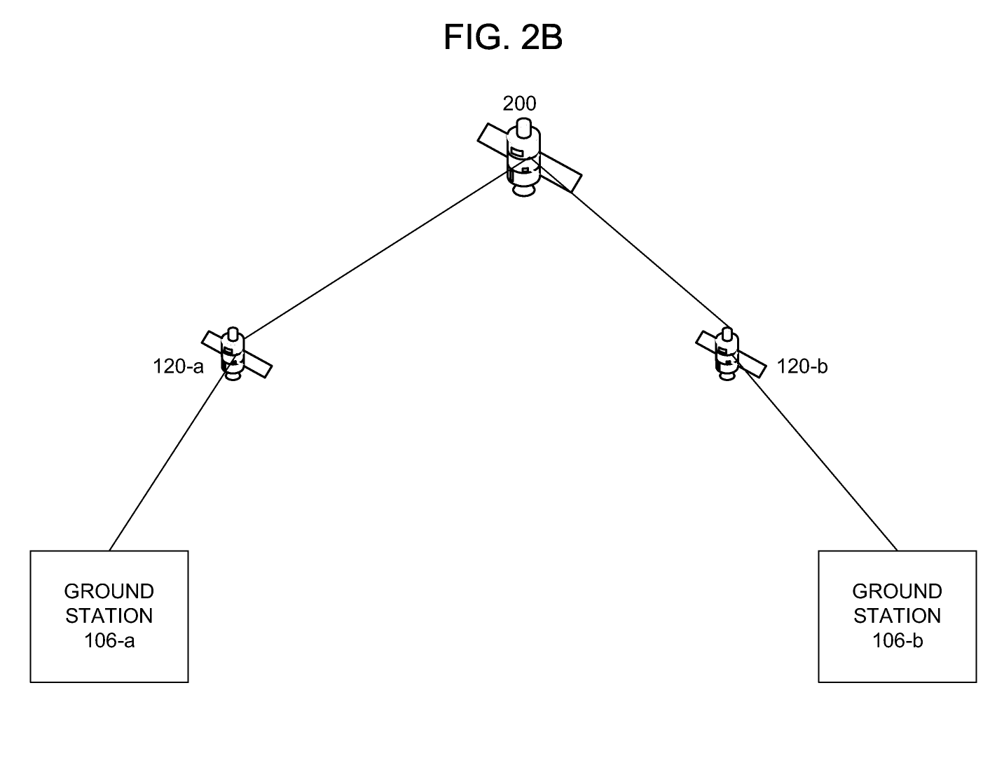

Herein, the terms “satellite system 104” and “satellites 104” are used interchangeably and generally refer to the totality of satellites employed as communication intermediaries in between gateway stations 102 and ground stations 106. Satellite system 104 may include one or more satellite constellations, wherein each constellation may include one or more satellites. Thus, satellite system 104 may include any number of satellites from one up to any desired number. Each satellite 200 (FIG. 2) of satellite system 104 may receive data from gateway 102 and retransmit such data either directly or via another satellite to one or more specified ground stations 106 and/or to any other satellite 200 within satellite system 104. Conversely, satellite system 104 may receive data from one or more ground stations 106 and retransmit the received data to gateway 102.

Ground stations 106 may be established in substantially permanently fixed locations and serve as a communications hub for networks of customer sites as shown in FIG. 2. In other embodiments, ground stations 106 may be mobile. For example, a ground station 106 may be implemented on a truck, trailer, or other vehicle capable of carrying and powering antenna systems capable of communicating with one or more satellites. Alternatively, a mobile ground station could be a semi-permanent platform, which is nevertheless moveable with suitable equipment when desired. Mobile ground stations 106 could be useful, for example, for providing information resources and communication to schools, hospitals and the like, in circumstances where such institutions cannot afford permanent ground stations at their respective locations.

Each ground station 106 may be connected to one or more subscribers, which may also be referred to as customer sites. Each subscriber may include one or more user terminals. The nature and communication bandwidth needs of the subscribers may vary widely. For instance, each subscriber may include one or more telephone companies, one or more Internet service providers, one or more Internet cafés, one or more individual communications customers, and/or other form of communication provider such as a cable television provider, or any combination of the foregoing.

FIG. 1 depicts a configuration which may be employed by satellites operating at any desired orbit around the Earth, including GEO (Geo-Stationary Orbit), Medium Earth Orbit (MEO), Highly Elliptical Orbit (HEO), or Low Earth Orbit (LEO). GEO occurs at an altitude of about 36,000 kilometers (km). MEO refers to orbits at altitudes between 2000 km and about 36,000 km above the surface of the Earth. LEO refers to orbits at altitudes lower than 2,000 km. Elliptical orbits refer to orbits in which the satellite altitude above the surface of the earth varies as a function of the angular position of the satellite along its orbit. HEO refers to elliptical orbits in which the distance of the satellite from the earth varies substantially as a function of time, or otherwise stated with advancement of the satellite along its orbit. Moreover, system 100 may enable communication between different ground stations using a single satellite 200 of satellite system 104 as an intermediary between the ground stations. Alternatively, two or more satellites 200 of satellite system 104 may communicate with respective ground stations 106 that are in the respective ranges of the two satellites. In this situation, gateway station 102 may communicate with the two satellites to enable communication between the two satellites, and thus between the two ground stations 106.

Alternatively, two satellites may serve as successive intermediaries between two ground stations, where no single satellite has a line-of-sight connection with both of the ground stations at the same time. Thus, the following sequences of links from a first ground station to a second ground station could be implemented. In one embodiment, the link could extend from a first ground station, to a satellite, to the second ground station, and then to a termination point at a customer site. In another embodiment, the link could extend from a first ground station, to a first satellite, then to a second satellite, then to the second ground station, and then to a termination point at a customer site. In other embodiments, any number of satellites could be employed as intermediaries between ground stations in communication with one another. The above embodiments are discussed further in connection with FIGS. 2, 2A, and 2B.

FIG. 2 is a block diagram of a portion of a communication system 100 in accordance with one or more embodiments of the present invention. The portion of communication system 100 shown in FIG. 2 may include satellite 200 and ground stations 106-a and 106-b on Earth 240. Since both ground stations 106-a and 106-b are coupled to equivalent sets of devices, for the sake of brevity, only the devices coupled to ground station 106-a are discussed below. Ground station 106-a may include dish 202-a, modem 204-a, computing system 210, which is shown in greater detail in FIG. 2A. Moreover, ground station 106-a may be in communication with customer sites CS1-a, CS2-a, and/or CS3-a. Ground station 106-b may include and be in communication with a set of devices paralleling that discussed above for ground station 106-a, as shown in FIG. 2. Dish 202-a may be any suitable telecommunications dish (also known as a satellite dish). Dish 202-a may be configured to track satellite 200 as satellite 200 proceeds along an orbit above ground station 106-a. While only one dish 202-a is shown, any number of dishes may be deployed at ground station 106-a, or other ground station within communication system 100. In one embodiment, two dishes 202 may be deployed at each ground station 106 which may operate in a round robin manner, to enable ground station 106 to hand off communication with satellite system (satellite constellation) 104 from one dish 202 to another, in a round robin manner, as a first satellite 200 proceeds out of range of ground station 106, and a second satellite gradually enters the range of ground station 106. In another embodiment, there may be two satellites 200 between ground stations 106a and 106b, wherein the signal path passes through the two satellites 200 and wherein the data transmission means employed between the two satellites may include optical transmission and/or radio frequency transmission.

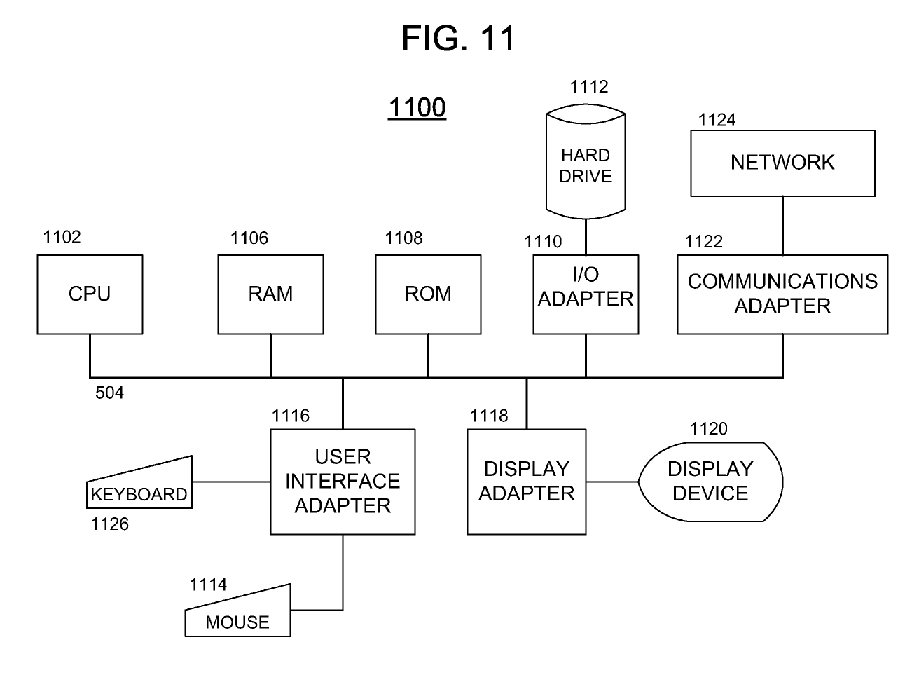

FIG. 2A is a block diagram of a portion of computing system 210 that may be deployed at, and/or be in communication with, ground station 106-a of FIG. 2. Computing system 210 may include all features needed to control all parts of ground station 106-a, such as the computer components shown in FIG. 11. However, for the sake of brevity, only a subset of the portions of computing system 210 are shown in FIG. 2A. Computing system 210 may include CPU 212 and memory 214. Data table 214 may be stored in memory 214 and may store data associating destination IP addresses of digital data packets with respective transmission frequencies. For the sake of illustration, FIG. 2A shows a simplified version of data table 216. Data table 216 includes simplified IP addresses 1001 and 1002, which correspond to customer site CS1-A and gateway station 102, respectively. It will be appreciated that in actual implementations, IP addresses may be presented in any format suitable for the pertinent application. Moreover, any number of IP addresses and associated transmission frequencies and/or transmission frequency ranges may be stored in data table 216. While much of the description herein discusses listing destination IP addresses in table 216, in other embodiments, address data stored in table 216 may include destination IP addresses, origination IP addresses, and/or the IP addresses one or more intermediate points along a data communication path for a data packet.

In an embodiment, at ground station 106-a (and/or at other comparably configured ground stations within communication system 100), computing system 210 may read the destination IP address of each digital data packet 250, access table 216 within memory 214, and retrieve the transmission frequency corresponding to the IP address read from the digital data packet 250. Thereafter, ground station 106-a may transmit analog data packet signal 260 using the transmission frequency retrieved from data table 216.

Data table 216 shows exemplary permissible frequency ranges that may be used for the respective IP addresses. Ground station 106-a preferably transmits each packet signal 260 using a transmission frequency anywhere within the transmission frequency range retrieved from data table 216 for a particular IP address. In some embodiments, the transmission frequency ranges of table 216 may be sub-divided into still smaller segments based on the point of origin of each digital data packet 250.

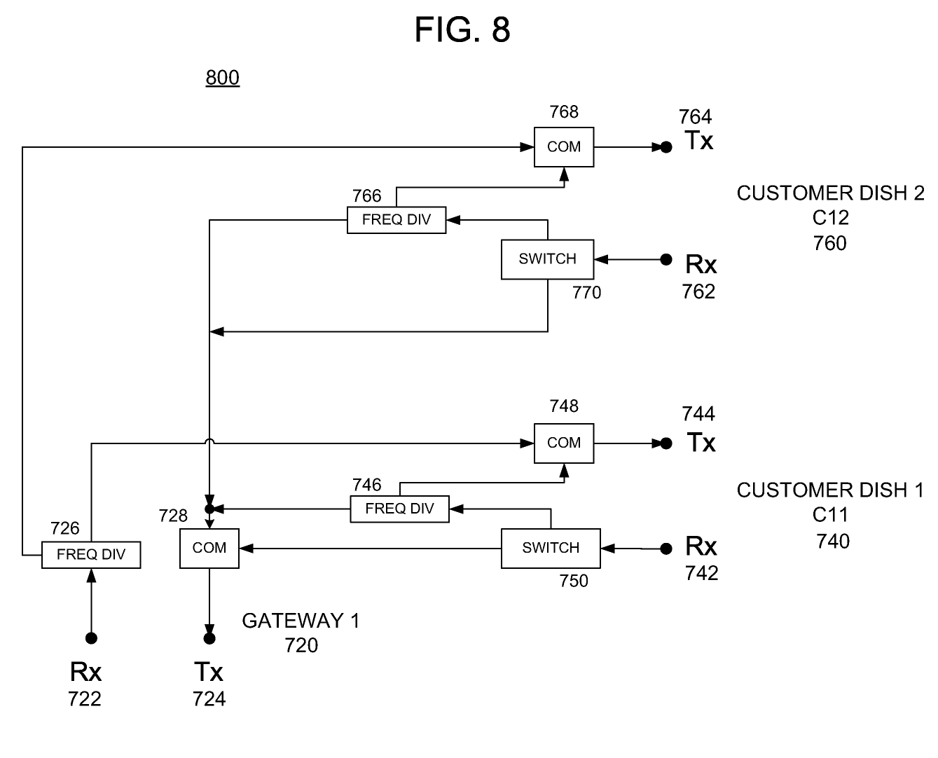

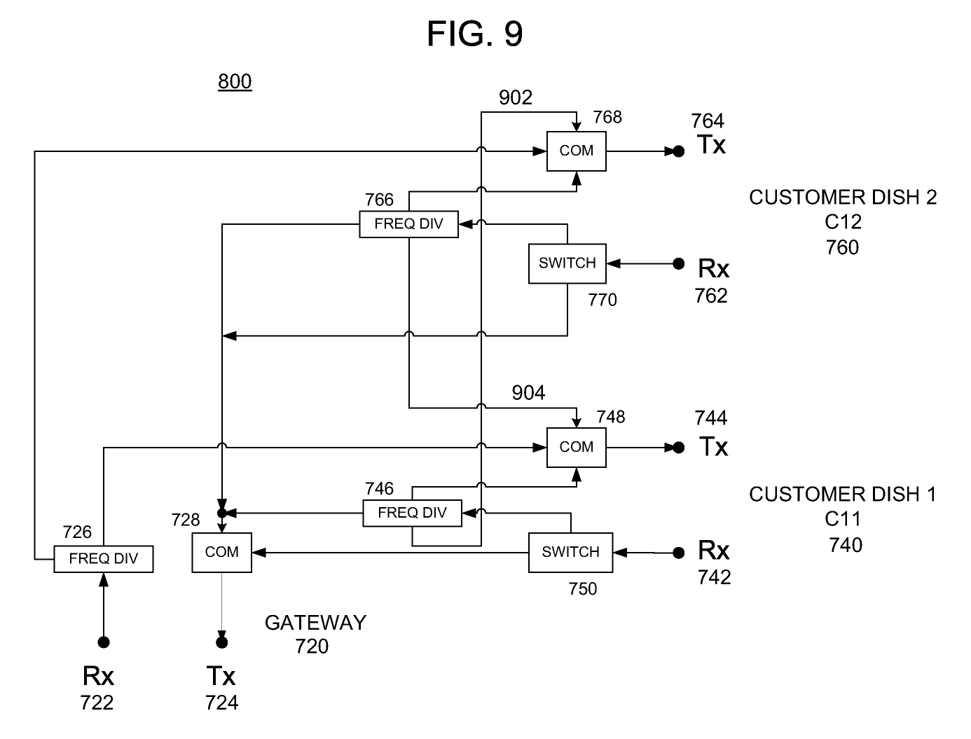

The association of a frequency range, instead of merely a single frequency, with a given IP address, may be helpful in establishing frequency division thresholds aboard satellite 200. This matter is discussed in greater detail in connection with FIGS. 8-9 herein. However, in brief, routing mechanisms, such as frequency dividers, may be deployed within satellite 200 for routing analog packet signals 260 therethrough. The transmission frequency ranges, such as those shown in table 216, corresponding to the respective IP addresses, may be employed to set thresholds in the frequency dividers in order to implement routing decisions aboard satellite 200 that are consistent with the data in table 216 and that are consistent with the manner in which transmission frequencies were selected for each packet signal 250 prior to being transmitted from ground station 106-1 to satellite 200. Thus, for instance, in accordance with this embodiment, a packet signal 260 received at satellite 200 having a transmission frequency of 19.011 GHz (see FIG. 2A) will preferably be routed by satellite 200 so as to be directed to IP address 1002, which in this case corresponds to gateway station 102.

In one embodiment, satellite 200 may serve as an intermediary for communication between ground station 106-a and 106-b. Thus, for example, a digital data packet 250 may be transmitted from customer site CS1-a to ground station 106-a. Suitable equipment (such as, but not limited to, modem 204-a and/or computing system 210) at ground station 106-a may then read the destination IP address of the digital data packet 250 and select a transmission frequency based on the destination IP address of that digital data packet 250. The digital data packet 250 may then be modulated by modem 204-a to provide an analog data packet signal 260 indicative of the digital data packet 250. The analog data packet signal 260 may then be transmitted from ground station 106-a to satellite 200 using the selected transmission frequency. Herein, the terms “packet” or “data packet” may be applied to both digital data packet 250 and analog data packet signal 260.

Satellite 200 then preferably receives the data packet signal 260 and preferably determines the transmission frequency of the received signal. Satellite 200 then preferably routes the data packet signal 260 to an output transponder (satellite dish) on satellite 200 that is selected based on the transmission frequency of the received data packet signal 260. Satellite 200 then preferably retransmits the data packet signal 260 out of the transponder along the intended path, which in this case leads to ground station 106-b. It is assumed for this example that the destination IP address identifies customer site CS1-b as its final destination. Thus, once the data packet signal 260 is received at ground station 106-b, modem 204-b preferably demodulates the signal back into digital data packet 250, and identifies the destination IP address. Ground station 106-b then preferably transmits the digital data packet 250 to customer site CS1-b.

In the above example, satellite 200 serves as an intermediary between ground stations 106-a and 106-b, each of which is coupled to multiple customer sites. However, satellite 200 may also be in communication with two or more ground-based communication stations of any suitable type. For instance, in other embodiments, satellite 200 may be an intermediary between a ground station and a gateway station, or between two gateway stations. Moreover, each satellite 200 may communicate with one or more satellites and/or with one or more ground stations.

FIG. 2B is a block diagram of a portion of a communication system in accordance with an embodiment of the present invention. The portion shown in FIG. 2B includes ground stations 106-a and 106-b, satellite 200, and satellites 120-a, and 120-b. For the sake of brevity, the details of ground stations 106-a and 106-b, discussed above in connection with FIG. 2, are not repeated in this section. Thus, in this embodiment, satellite system 104, shown generally in FIG. 1, may include satellites 120 as well as satellites 200. Moreover, data packets being transmitted through communication system 100 may be transmitted through two or more satellites within satellite system 104 as such packets progress from gateways 102 toward ground stations 106, or as such packets progress from ground stations 106 toward gateways 102. Transmitting a packet through a plurality of satellite “hops” in this manner may be beneficial if a given satellite does not have line-of-sight communication with two ground stations at the same time.

In this embodiment, the data communication link between ground stations 106-a and 106-b may proceed from ground station 106-a to satellite 120-a to satellite 200, to satellite 120-b, and ultimately to ground station 106-b. While the embodiment of FIG. 2B shows three satellites serving as communication intermediaries between ground stations 106-a and 106-b, it will be appreciated fewer or more than three satellites could be used in this manner. In one embodiment, satellites 120 may travel in a first orbit, and satellites 200 may travel along a different orbit (i.e. differing in one or more of altitude, latitude, inclination, and so forth). However, in other embodiments, satellites 120 and 200 may travel within the same orbit.

Herein, a transceiver station may be either a ground station 106, or a satellite 120 or 200. Thus, a transceiver station may be any intermediary communication device capable of receiving and retransmitting a digital data packet or a data packet signal. Moreover, in some embodiments, either ground stations 106 or satellites 200 may transmit data to one or more communication devices that can only receive data (receivers); and/or may receive data from one or more communication devices that only transmit data (transmitters). Herein, a communication device is any device capable of receiving data and/or of transmitting data. Thus, the present invention is not limited to employing communication devices that are capable of both transmitting and receiving data.

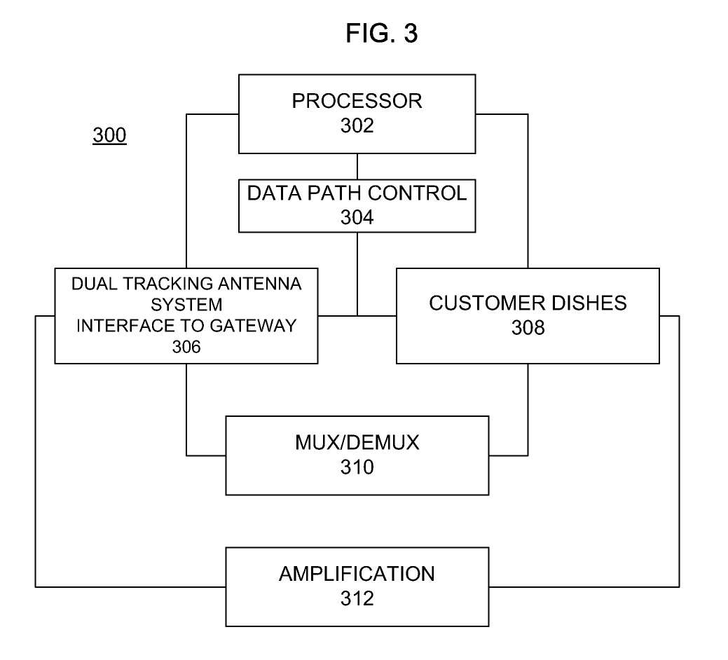

FIG. 3 is a block diagram of the electrical hardware 300 aboard a satellite 200 in accordance with one or more embodiments of the present invention. Satellite hardware 300 may include processor 302, data path control 304, tracking antenna system 306, customer dishes 308, MUX 310, and/or amplification equipment 312.

Processor 302 may be a general processor having access to volatile and/or non-volatile memory. Processor 302 may be operable to coordinate the flow of data among the gateway dishes and customer dishes 308. Data path control 304 is preferably operable to control the flow of data from various transponder inputs, along waveguides, and to various transponder outputs within satellite 200. Data path control 304 may be implemented using one or more MUX frequency splitters, by processor 302, by other devices, or using a combination of one or more of the foregoing.

Dual tracking antenna system 306 may be a communication interface in between gateway 102 (FIG. 1) and the remainder of the communication equipment on satellite 200. Dual tracking system 202 may include two or more mechanically or electronically steerable antennas and/or communication data conversion equipment for interfacing between gateway 102 and communication equipment on satellite 200. In alternative embodiments, a single gateway antenna may be employed. In one embodiment, communication system 100 may be configured such that satellite 200 is always situated so as to be able to communicate with at least one gateway 102 station. In other embodiments, a higher minimum number of communication paths between each satellite 200 and gateway stations 102 may be maintained. Specifically, in some embodiments, communication system may be configured to ensure that one or more satellites 200 within satellite system 104 maintain communication paths with at least two gateway stations 102 at all times.

Customer dishes 308 are preferably any one of several types of satellite communication dishes capable of bi-directional communication with one or more ground stations, one or more other satellites, and/or a combination of ground stations and other satellites. Satellite 200 may include any number of customer dishes 308.

MUX/DEMUX 310 generally refers to equipment for combining signals from a plurality of sources onto a single waveguide and equipment for separating out signals on a single waveguide onto a plurality of different waveguides. Particular features of these functions are described in greater detail later in this document. Any needed combination of separate multiplexers and/or demultiplexers may be employed to fulfill the function of block 310.

Amplification 312 may be provided by one or more conventional radio frequency (RF) amplifiers which are known in the art, and which could be composed of either a traveling wave tube amplifier (twta) or solid state power amplifier (sspa). Accordingly, a detailed description of amplifiers that can perform the amplification 312 function is not provided herein. One or a plurality of amplifiers may be provided as part of hardware 300 of satellite 200.

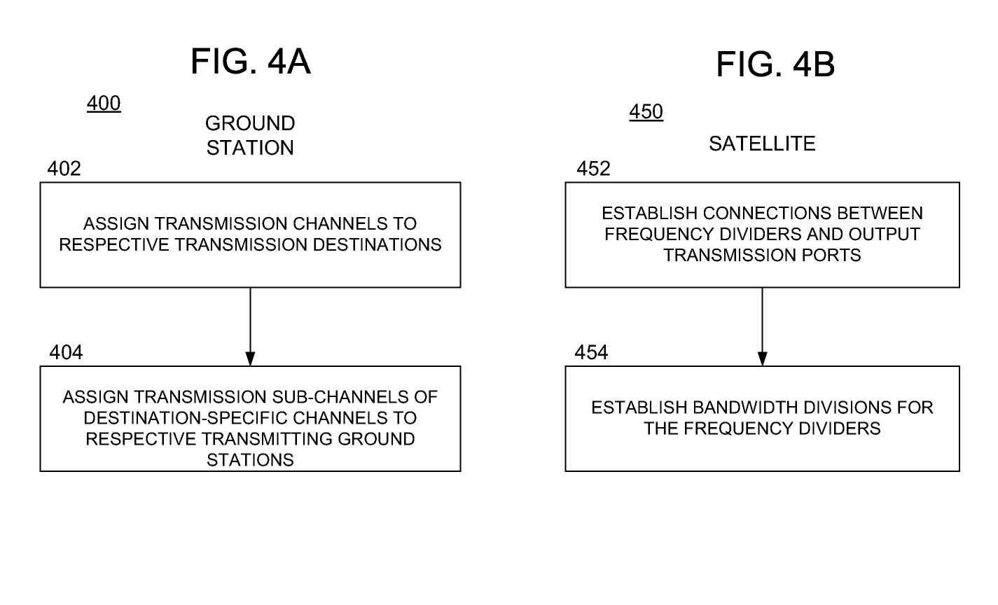

FIG. 4A is a flow diagram of a series of steps 400 that may be performed to configure modem 204 and ground station 106 for transmitting data in accordance with one or more embodiments of the present invention.

Frequency based routing may inexpensively implemented within a satellite 200 by employing the transmission frequency of a data packet signal as an indicator of the destination of the data packet. This arrangement preferably involves coordinating an association of destinations and transmission frequencies at each ground station with a corresponding frequency-destination association on each satellite within communication system 100.

At step 402, a plurality of transmission frequency channels may be assigned to a plurality of respective transmission destinations. Preferably, the association of transmission frequencies, or frequency ranges in the form of “channels,” operates to encode destination information for digital data packet 250 into the transmission frequency used to transmit the data packet signal 260. The resulting transmission frequency is preferably later used by equipment aboard a satellite 200 to suitably route the data packet signal 260.

Herein, the term “channel” corresponds to a frequency range of a carrier frequency (transmission frequency) used for transmitting signals, such as data packet signals 260. In some embodiments, the bandwidth of each such transmission channel may be 10 MHz. However, in other embodiments, channel bandwidths may be lower than or greater than 10 MHz.

The degree of precision indicated by transmission using a given channel may be established according to the needs of particular network. For instance, if the number of available transmission channels equals or exceeds the number of possible destination IP addresses, then one channel may be assigned to each IP address without running out of channels. Alternatively, where the number destination IP addresses exceeds the number of available channels, channels of a given bandwidth, such as 10 MHz may each be assigned to a grouping of IP addresses. This grouping of IP addresses may form part of a common network, may be coupled to a common ground station 106 (FIG. 2), may be located within a defined geographical region on the Earth, and/or have another communication-related feature in common.

The above-described flexibility in the assignment of transmission channels to communication destinations is possible because, in most embodiments, the practice of having the transmission frequency of a data packet signal 260 serve as a proxy for transmission destination is beneficial primarily for routing the data packet signal 260 through a satellite 200 and on to a ground station 106. Once the data packet signal reaches a ground station 106, the signal may be demodulated into a digital data packet 250. Thereafter, further routing of the data packet 250 may be achieved by reading the destination IP address bits incorporated into the data packet 250 using equipment designated for this purpose that is readily available at Earth-based communication hubs.

Thus, depending on the circumstances, the transmission frequency may be associated with a range of data packet routing detail. The transmission frequency preferably specifies, at a minimum, which one of a number of ground stations 106 a transmitted data packet signal 260 will be transmitted to. However, the transmission frequency could specify more detail, up to and including the final IP address of a computer that will receive the data packet 250. In still other embodiments, where for instance communication to a destination device passes through a number of intermediate communication devices in between a destination ground station and a final destination, the level of destination detail specified by a transmission frequency may be such as to specify any desired level of detail in between specifying the destination ground station and the final data packet destination. More specifically, the transmission frequency could specify an extent of transmission through any desired number of the above-mentioned intermediate communication devices.

At step 404, the selection of transmission frequency ranges for the transmission of data packets may be adjusted based the location from which the data packet originates. The transmission frequency range may be selected based on an identification of the ground station 106 from which the data packet is being transmitted and/or an identification of a customer site, such as CS1 (FIG. 2), from which the data packet originated. This may be desirable where a plurality of modems at a plurality of different respective ground stations all use the same transmission channel.

In one or more embodiments, the frequency ranges associated with various respective transmission sources may be sub-channels of channels that are associated with respective transmission destinations. Thus, an example is considered in which a channel “A” is employed to transmit to a given ground station 106-a. In this situation, individual modems serving as sources for data destined for ground station 106-a may experience data flow rates that are well within their operating limits. However, if the data flow rates from the various modems are combined within satellite 200 so as to be transmitted out of a single satellite transponder, the transmission capability of the single satellite transponder could be exceeded.

In one embodiment, this congestion may be alleviated by allocating portions of channel A, referred to herein as “sub-channels,” to modems at different ground stations, that are all processing data packets destined for ground station 106-a. Thus, where four source ground stations GS1, GS2, GS3, and GS4 are directing data traffic to ground station 106-a, four separate sub-channels of channel A (e.g. A1, A2, A3, and A4) could be assigned to the four transmitting ground stations GS1, GS2, GS3, and GS4, respectively. In one embodiment, the bandwidth of channel A could divided equally among the four sub-channels, thereby providing each sub-channel with about 2.5 MHz of bandwidth.

Additionally or alternatively, in other embodiments, the available data communication throughput for a channel, such as channel A in the example above, may be dynamically allocated among a plurality of modems based on the data communication throughput needs of the various modems.

FIG. 4B is a flow diagram of a series 450 of steps that may be performed to configure communication equipment on a satellite 200 for transmitting data in accordance with one or more embodiments of the present invention.

In an embodiment, frequency based routing may be implemented on one or more satellites in a manner consistent with the above-discussed assignment of transmission frequencies to data transmission destinations at the various ground stations 202. Preferably, the routing of data packet signals through satellite 200 is established in coordination with the association of transmission frequencies with destination IP addresses conducted in step 402, at a ground station 106.

At step 452, on each satellite 200, connections may be established between frequency dividers and selected output transponders, using suitable equipment, such as waveguides. Continuing with the example discussed above, signals having a transmission frequency corresponding to the frequency range of channel A are preferably routed to an output transponder on satellite 200 that is configured to transmit to ground station 106-a. In this manner, satellite 200 is preferably able to route a data packet signal by using the transmission frequency of the signal as a proxy for the destination IP address. Various options exist for implementing this signal routing which will be discussed in greater detail in connection with FIGS. 8 and 9 of this application. In one embodiment, establishing routing connections on satellite 200 as a function of transmission frequency may be conducted once, upon configuration of satellite 200, and may remain in place for the operating life of the satellite 200. However, in other embodiments, adjustable routing may be implemented such that control signals directed to an orbiting satellite may be operable to change the transmission destination of a signal having a transmission frequency within a given frequency range, such as, for example, between 18.5 GHz (Gigahertz) and 18.6 GHz.

At step 454, bandwidth divisions may be implemented for one or more frequency dividers aboard satellite 200. An example is considered in which a given frequency divider is set up to receive data packet signals that may be directed along one of two possible paths: a) back out to a transponder, or b) toward a gateway. For the sake of this example, the frequency divider is assumed to receive signals having a transmission frequency range (bandwidth) of 20 MHz.

A bandwidth division for the frequency divider is preferably established based on the expected data communication flow expected for the two respective output paths from the divider. In most embodiments, once established, the bandwidth division of the frequency divider will remain in effect indefinitely. However, where possible, an adjustable bandwidth division mechanism may be implemented that will enable alteration of the bandwidth division even after satellite 200 is placed in orbit. The bandwidth division may depend on various factors including the communication requirements of the regions served by the satellite 200. For example, a satellite serving a region having limited wired connections on the ground may have a large proportion of its bandwidth allocated to retransmission of data out of the transponder pointing to the point of origin. For example, in the above situation, 80% of the bandwidth could dedicated to retransmission out of the transponder, and the remaining 20% could be directed to the gateway for eventual routing to one or more other regions on the Earth.

In some embodiments, different frequency dividers on a given satellite 200 may have different bandwidth divisions implemented therein. Thus, as the satellite 200 orbits over service regions having different needs, different transponder input-frequency divider paths may be activated to receive data from the respective regions. In regions having an extensive need for data retransmission back down to the service area, the above-described 80%-20% backhaul-gateway division could be implemented. In contrast, when the satellite is over areas not requiring much local retransmission, a different bandwidth allocation could be implemented. Thus, over this latter type of service area, an 20%-80% backhaul-gateway division could be implemented, in which only 20% of the bandwidth is retransmitted back over the satellite-dish service area that the satellite 200 is positioned over at a given moment in time.

The foregoing describes embodiments in which the transmission frequency of a packet signal 260 is employed as a proxy for a destination IP address of the packet signal 260 to enable relatively simple, analog devices aboard satellite 200 to conduct frequency-based routing without having to demodulate packet signal 260 and read the IP address thereof. However, in other embodiments, characteristics of the analog packet signal 260 other than frequency could be modified to enable signal routing to be performed aboard satellite 200 without signal demodulation. These other analog signal characteristics may include but are not limited to: amplitude and signal shape or other recognizable pattern. Thus, in such cases, one or more of these other characteristics could be employed aboard satellite 200 as proxies for destination IP address either in addition to, or as an alternative to, the transmission frequency of analog packet signal 260.

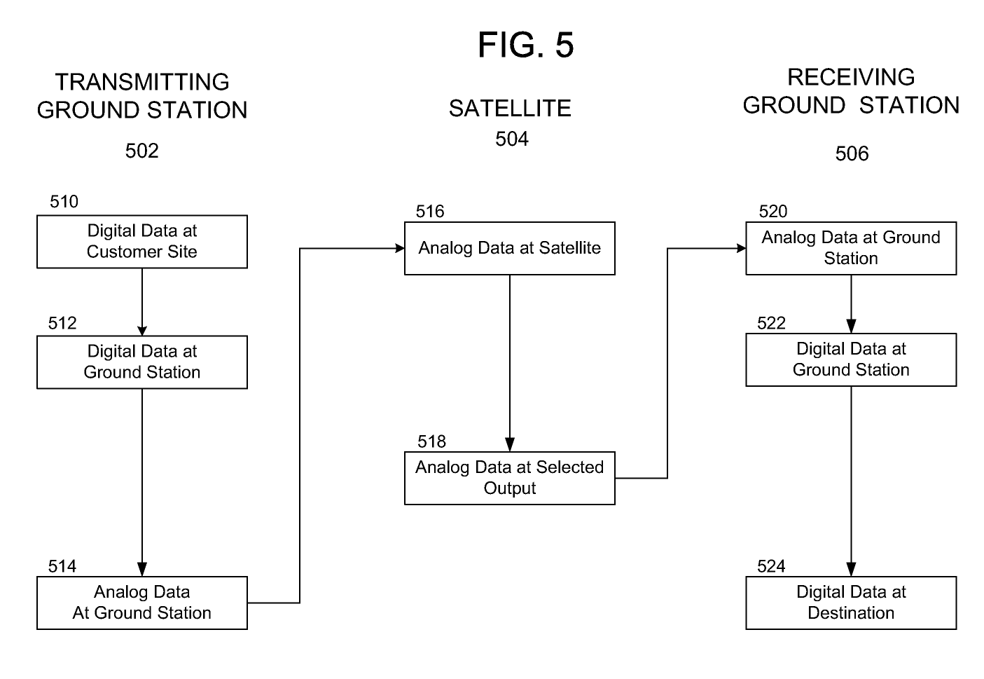

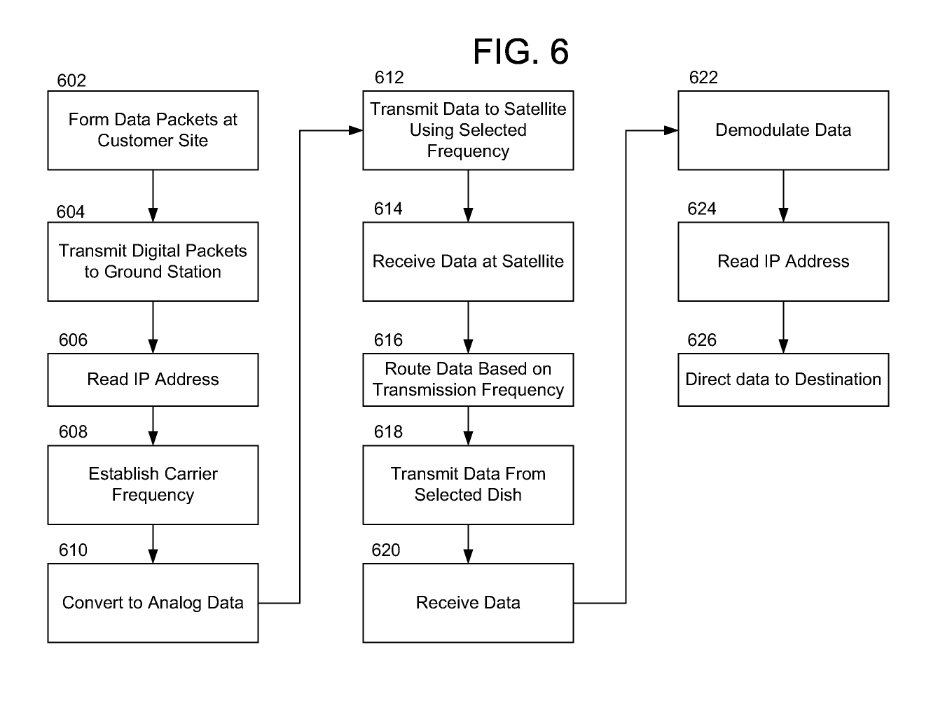

FIG. 5 is block diagram showing the location and condition of an exemplary data packet 250 (FIG. 2) transmitted through a communication system in accordance with one or more embodiments of the present invention. FIG. 6 is a flow diagram of a method for routing a data packet through a communication system in accordance with one or more embodiments of the present invention. FIGS. 5 and 6 are discussed together below.

FIG. 5 shows states of digital data packet 250 and analog data packet signal 260 at various stages of the data transmission process. FIG. 5 shows these states divided into three broad categories: those occurring at a ground transmission location 502, on a satellite 200 (location 504), and a receiving ground station location 506.

At step 602, digital data packets 250 are formed at one or more customer sites (state 510) and transmitted (step 604) to a designated ground station, thereby providing digital data at ground station (state 512). At step 606, the destination IP address of packet 250 may be read. At step 608, the carrier frequency, which may also be referred to as the “transmission frequency” to be used to transmit data packet 250 may be established based on the destination IP address, as discussed in connection with FIG. 4.

At step 610, data packet 250 may be converted into analog data (state 514), thereby providing data packet signal 260 (FIG. 2). At step 612, the data packet signal 260 may be transmitted to satellite 200 using the frequency selected in step 608, and be received at the satellite at step 614, thereby providing analog data (state 516) at satellite 200.

Once within satellite 200, the data packet signal may be routed (step 616) based on the transmission frequency thereof, thereby directing the data packet signal 260 to a selected output transponder (state 518) of satellite 200. At step 618, data packet signal 260 may be transmitted out of the selected satellite transponder toward the destination indicated by the transmission frequency of data packet signal 260. At step 620, the data packet signal 260 may be received at the receiving ground station (state 520). At step 622, suitable equipment, such as modem 204-b, may be employed to demodulate data packet signal 260 to provide digital data packet 250 at the receiving ground station (state 522). At step 624, the IP address of data packet 250 may be read to further route digital data packet 250 based on the destination IP address thereof. At step 626, digital data packet 250 may be routed to its final destination (state 524).

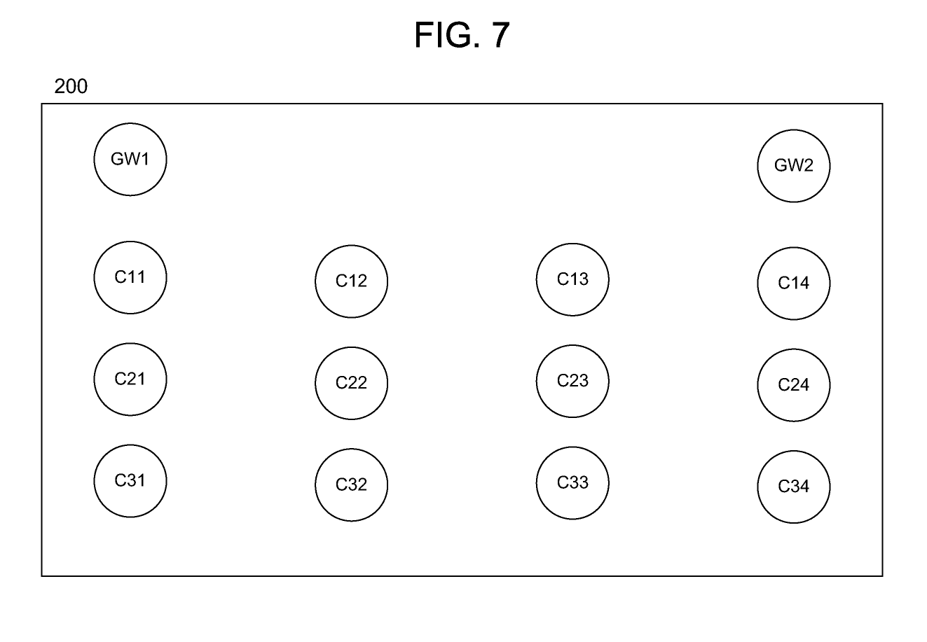

FIG. 7 is a block diagram showing a plurality of transponders on satellite 200 in accordance with one or more embodiments of the present invention. In this embodiment, the transponders may both transmit and receive wireless radio frequency communication.

Satellite 200 may include gateway transponders GW1 and GW2 for communication with two respective gateway stations on the ground (not shown). In other embodiments, satellite 200 could include fewer or more than two gateway transponders. Satellite 200 may further include twelve transponders for communication with ground stations that are in communication with customers, including transponders C11, C12, C13, C14, C21, C22, C23, C24, C31, C32, C33, and C34. While twelve transponders directed to customer communication are shown in FIG. 7, fewer or more than twelve transponders could be included within satellite 200.

In one embodiment, data received at an input of any of the transponders of satellite 200 show in FIG. 7 may be routed so as to be output from any of the fourteen transponders, including the transponder that the data was received at. In other embodiments, to achieve greater economy, a more limited set of signal transmission routing options may be made available within one or more satellites 200 within a constellation of such satellites. This matter is discussed in greater detail in connection with FIGS. 8 and 9.

FIG. 8 is a block diagram showing a portion of the signal routing apparatus 800 on satellite 200 configured in accordance with one or more embodiments of the present invention. In one embodiment, portions of apparatus 800 constitute one of several possible implementations of the functional blocks shown in FIG. 3. For the sake of brevity, hardware corresponding to various blocks of FIG. 3, such as processor 302 and amplification 312, are not shown in FIGS. 8 and 9.

For the sake of simplicity of illustration, signal routing apparatus 800 shows one possible arrangement of signal connections for two customer transceivers 740,760 (which are also referred to herein as “transponders” and “dishes”) and one gateway transceiver 720. The dishes shown in FIG. 8: Gateway 1, and customer dishes C11 and C12, are a subset of those shown in FIG. 7. However, it will be apparent to those of skill in the art that the concepts shown in FIGS. 8 and 9 may be extended to all twelve customer dishes and the two gateway dishes shown in satellite 200 of FIG. 7, and in other embodiments, to any number of gateway dishes and/or customer dishes.

FIG. 8 is directed to an embodiment in which data packet signals 260 arriving at a receiver (denoted “Rx” in FIG. 8) of a gateway dish or customer dish are typically output along one of two possible directions. Specifically, the incoming signal may be directed back out of the dish it was received at, for intra-region backhaul, that is, back to the region the data packet signal was transmitted from in the first place. This approach may be beneficially employed in regions in which various ground stations 106 are simultaneously in communication with a common satellite 200, but which are not in communication with one another via ground-based connections or where the cost of such terrestrial communications is excessive.

A second possible routing direction is toward a gateway station of network 100 that is in communication with a ground-based communication network, such as communication network 108 (FIG. 1). After being transmitted to a gateway station, a signal may be further routed to a suitable destination by other portions of communication network 100.

Signal routing apparatus 800 may include gateway 1 dish (GW1) 720, customer dish 1 (C11) 740, and customer dish 2 (C12) 760. Gateway dish 720 may include input port Rx 722 which may be coupled to frequency divider 726; and output port 724 which may be coupled to combiner 728. Customer dish 740 may include input port Rx 742 which may be coupled to switch 750, which may in turn be coupled to frequency divider 746; and output port 744 which may be coupled to combiner 748. Customer dish 760 may include input port Rx 762 which may be coupled to switch 770, which may in turn be coupled to frequency divider 766. Customer dish 760 may further include output port 764 which may be coupled to combiner 768.

The satellite communication dishes 720, 740, and 760 may be conventional satellite dishes capable of bi-directional communication with Earth based ground stations and/or with other satellites. Switches 750 and 770 may be conventional waveguide switches. Combiners 728, 748, and 768 may be conventional signal combiners.

Frequency dividers 726, 746, and 766 may be conventional frequency dividers, which may be OMUX frequency dividers. In some embodiments, each frequency divider may be configured during a setup phase of the satellite to direct signals within a plurality of frequency ranges along a plurality of respective signal routing directions. For example, frequency divider 746 could be configured to process signals having transmission frequencies between 19.0 GHz and 19.1 GHz. In this situation, the frequency bandwidth handled by frequency divider is 0.1 GHz, which may also be expressed as 100 MHz. In one embodiment, frequency divider 746 could be configured to direct signals having transmission frequencies greater than or equal to 19.00 GHz and less than 19.01 GHz toward combiner 748 for retransmission out of output port 744 of customer dish 740. In this example, frequency divider 746 may direct signals having transmission frequencies greater than or equal to 19.01 GHz and less than or equal to 19.1 GHz toward combiner 728 for transmission out of output port 724 of gateway dish 720. In this manner, frequency divider 746 effectively implements frequency based routing, using transmission frequency as a proxy for data packet signal destination information, in accordance with one or more embodiments of the present invention.

In alternative embodiments, frequency divider 746 could be configured to have a frequency division scheme that is adjustable while the satellite 200 (that frequency divider 746 is located on) is in orbit. Such adjustment would be preferably be accomplished remotely from a ground location by transmitting a specified set of radio frequency signals to a suitable control mechanism for adjusting the frequency division threshold of frequency divider 746. While the above is directed to a frequency divider having two possible output paths, any number of output paths may be provided. The provision of three or more output paths from frequency divider 746 may be enabled using a single frequency divider having three output paths and/or by providing a succession of frequency dividers, with two output paths each, having suitably configured frequency thresholds for implementing routing decisions.

In the following, the general operation of apparatus 800 in accordance with one embodiment is discussed, followed by a more specific example. The apparatus 800 of FIG. 8 may be operable to receive signal energy, such as data packet signals, at a plurality of input ports, route the signals based on the transmission frequencies thereof, perform any needed signal treatment, such as amplification, and then retransmit the signals out of satellite 200 toward the destinations indicated by the transmission frequency of each signal.

Signals may arrive at gateway dish 720 input port 722. Thereafter, the incoming signals may be routed at frequency divider 726 based on the transmission frequencies of the respective signals. Thereafter, the signals may be directed to combiner 748 and out of customer dish 740 and/or to combiner 768 and out of customer dish 760, in accordance with the signals' respective transmission frequencies. Each of combiners 728, 748, and 768 is preferably operable to join signals having differing sources onto a single waveguide for transmission out of a single dish.

In one embodiment, signals arriving at customer dish 740 input 742 may proceed to switch 750. Switch 750 may be set to either transfer all signal energy to combiner 728 for retransmission out of gateway dish 720 output port 724 or to direct all signal energy arriving thereat to frequency divider 746 for division thereat in accordance with a bandwidth division scheme in effect at frequency divider 746. Assuming the signals are directed to frequency divider 746 from switch 750, after the frequency division, the signal energy may be directed toward combiner 728 and/or combiner 748 in accordance with the frequency division scheme, for transmission out of gateway output 724 and/or customer dish 1 output 744.

Signals arriving at input port 762 of customer dish 760 may be processed in a manner parallel to that discussed above in connection with signal energy arriving at customer dish 740. Since the routing circuit for processing signal energy input to customer dish 760 is essentially the same as that used for customer dish 740, a detailed discussion of the routing of signal energy arriving at customer dish 760 is omitted for the sake of brevity.

An example is considered in which signal energy including signals with two different transmission frequencies arrive at input port 742 of customer dish 740: a) a first signal having a transmission frequency of 19.005 GHz and b) a second signal having a transmission frequency of 19.05 GHz. For this example, we resume the frequency division threshold discussed above for frequency divider 746. Specifically, signals with transmission frequencies greater than or equal to 19.00 GHz and less than 19.01 GHz are directed to output port 744 of customer dish 740; and signals with transmission frequencies greater than or equal to 19.01 GHz and less than or equal to 19.1 GHz are directed to combiner 728 for transmission out of output port 724 of gateway dish 720.

Continuing with the example, both signals arrive at input port 742 of customer dish 740. For the sake of this example, switch 750 is set to direct all signal energy toward frequency divider 746. Thus, both signals get transmitted to frequency divider 746. Frequency divider 746 is preferably operable to direct the first signal, having a transmission frequency of 19.005 GHz, toward combiner 748 for retransmission out of output port 744 of gateway dish 740, thereby providing intra-region backhaul to the region the signal was received from. Frequency divider is preferably also operable to direct the second signal, having a transmission frequency of 19.05 GHz, toward combiner 728 for retransmission out of output port 724 of gateway dish 720.

In the above manner, apparatus 800 may be operable to conduct frequency-based routing using frequency dividers, such as frequency divider 746. Moreover, in this embodiment, when the apparatus 800 is employed in coordination with the previously described assignment of transmission frequencies as a function of data packet destination (at ground station 106), the frequency based routing operation of apparatus 800 effectively uses signal transmission frequency as a proxy for destination information, and thereby effectively conducts destination IP address based routing without the expense, complexity, vulnerability, and risk of obsolescence associated with employing digital routing equipment aboard satellite 200.

FIG. 9 is a block diagram showing a modified version of the signal routing apparatus 800 of FIG. 8. The embodiment of FIG. 9 is intended to demonstrate the routing flexibility available using one or more embodiments of the present invention. Specifically, signal energy received at the input of a customer dish may be routed to one or more other customer dishes in addition to, or as an alternative to, routing such received signal energy back out of the output port of the receiving dish or out of the output port 724 of the gateway 720.

The apparatus 800 of FIG. 9 includes two routing connections in addition to the equipment shown in FIG. 8. Specifically, the embodiment of FIG. 9 may include link 902 and/or link 904 in addition to the other connections. In this embodiment, communication link 902 may extend from frequency divider 746 to combiner 768 to enable signal energy to be transmitted out of output port 764 of customer dish 760. Link 904 may extend from frequency divider 766 to combiner 748, to enable signal energy to be transmitted out of output port 744 of customer dish 740.

Links 902 and 904 are preferably operable to enable signals to be routed from the input of one customer dish to the output port of another customer dish. The previously discussed example is resumed in the following to illustrate the operation of this embodiment. In the modified example, signals (directed to frequency divider 746) with transmission frequencies greater than or equal to 19.00 GHz and less than 19.01 GHz are directed to combiner 748 and then to output port 744 of customer dish 740. Signals with transmission frequencies greater than or equal to 19.01 GHz and less than or equal to 19.1 GHz are directed to combiner 728 for transmission out of output port 724 of gateway dish 720. And, signals with transmission frequencies between 19.1 GHz and 19.2 GHz are directed to combiner 768 for transmission out of output port 764 of customer dish 760. The above-described three-way division of signal energy directed into frequency divider 746 may be implemented using a single frequency divider or by employing a succession of two frequency dividers each having two outputs.

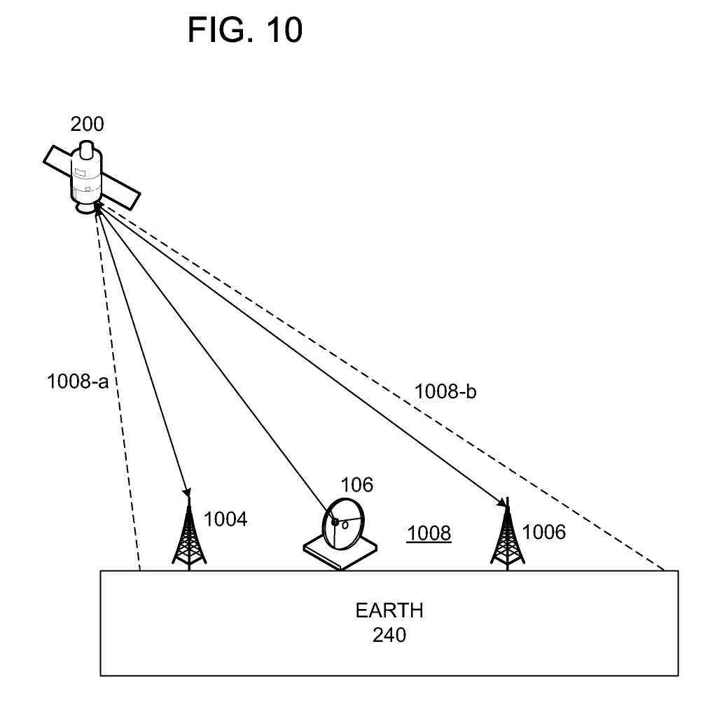

FIG. 10 is a schematic diagram of satellite 200 in communication with its broadcast area 1008 on the Earth 240, in accordance with one or more embodiments of the present invention. FIG. 10 is provided to illustrate the utility of employing satellite 200 for backhaul communication from ground station 106 (at which a satellite dish is shown) to towers 1004 and/or 1006 that are within the broadcast area 1008, on the Earth 240, of satellite 200. Broadcast area 1008 is shown bounded by dashed lines 1008-a and 1008-b.

A case is considered in which ground station 106 possesses data intended for delivery to one of towers 1004 or 1006, but no ground-based, wired connection connects towers 1004 and 1006. In this case, ground station 106 may transmit data to satellite 200. Preferably, the transmission frequency of the data packet signal sent to satellite 200 is properly associated with the intended destination of the data packet, both at ground station 106 and within satellite 200. In accordance with the principles discussed in connection with FIGS. 8-9 of this application, a data packet signal 260 reaches satellite 200, and may be routed toward a transponder on satellite 200 that broadcasts to region 1008. Thereafter, one or both of towers 1004 and 1006 may receive the data packet signal 250, demodulate the packet, and examine the destination IP address. Any tower (for example, tower 1004) that demodulates the packet and that is not connected to the intended packet destination may simply discard the packet. If, for example, tower 1006 demodulates the packet and discovers that a customer connected (over a land-based connection) to tower 1006 is the intended destination of the packet, tower 1006 may suitably route the demodulated digital data packet 250 to the intended destination using conventional digital data transmission technology.

FIG. 11 is a block diagram of a computing system 1100 adaptable for use with one or more embodiments of the present invention. For example one or more portions of computing system 1100 may be employed to perform the functions of computing system 210 of FIGS. 2 and 2A, processor 302 and/or data path control 304 of FIG. 3, of gateway 102 of FIG. 1, and/or of one or more processing entities within communication network 100 of FIG. 1.

In one or more embodiments, central processing unit (CPU) 1102 may be coupled to bus 1104. In addition, bus 1104 may be coupled to random access memory (RAM) 1106, read only memory (ROM) 1108, input/output (I/O) adapter 1110, communications adapter 1122, user interface adapter 1106, and display adapter 1118.

In one or more embodiments, RAM 1106 and/or ROM 1108 may hold user data, system data, and/or programs. I/O adapter 1110 may connect storage devices, such as hard drive 1112, a CD-ROM (not shown), or other mass storage device to computing system 1100. Communications adapter 1122 may couple computing system 1100 to a local, wide-area, or Internet network 1124. User interface adapter 1116 may couple user input devices, such as keyboard 1126 and/or pointing device 1114, to computing system 1100. Moreover, display adapter 1118 may be driven by CPU 1102 to control the display on display device 1120. CPU 1102 may be any general purpose CPU.

It is noted that the methods and apparatus described thus far and/or described later in this document may be achieved utilizing any of the known technologies, such as standard digital circuitry, analog circuitry, any of the known processors that are operable to execute software and/or firmware programs, programmable digital devices or systems, programmable array logic devices, or any combination of the above. One or more embodiments of the invention may also be embodied in a software program for storage in a suitable storage medium and execution by a processing unit.

Although the invention herein has been described with reference to particular embodiments, it is to be understood that these embodiments are merely illustrative of the principles and applications of the present invention. It is therefore to be understood that numerous modifications may be made to the illustrative embodiments and that other arrangements may be devised without departing from the spirit and scope of the present invention as defined by the appended claims.

1. A communication system comprising:
a plurality of ground stations operable to transmit and receive analog signal energy;
at least one satellite in orbit around the earth and in communication with at least two said ground stations, wherein the satellite comprises:
a plurality of transponders, wherein at least two said transponders are configured to communicate with at least two different communication devices; and
at least one routing mechanism for routing an analog data packet signal received at the satellite to a selected one of said at least two transponders based on a transmission frequency of each said analog data packet signal.

2. The communication system of claim 1 wherein a transmission path of said analog data packet signal through said satellite includes only analog equipment.

3. The communication system of claim 1 wherein the routing mechanism comprises at least one frequency divider.

4. The communication system of claim 1 wherein the routing mechanism is operable to select from a) a first said transponder broadcasting toward a footprint on the earth in proximity to a current location of the satellite; and b) a second said transponder configured to communicate with a gateway station, for rebroadcast of analog data packet signals routed by said routing mechanism.

5. The communication system of claim 4 wherein said first transponder broadcasting toward said proximate footprint is operable to provide intra-region backhaul between transceiving devices within said footprint not having land-based, wired connections disposed therebetween.

6. The communication system of claim 1 further comprising:
a computing system in communication with at least one said ground station, the computing system having a memory for storing a data table containing a plurality of IP addresses and a respective plurality of transmission frequencies corresponding to the IP addresses.

7. The communication system of claim 6 wherein the computing system is operable to read IP (Internet Protocol) addresses of digital data packets received at the ground station.

8. The communication system of claim 7 wherein the computing system is operable to retrieve a transmission frequency corresponding to the IP address of each said received digital data packet.

9. The communication system of claim 8 wherein the at least one ground station comprises a modem for converting the received digital data packets into respective analog data packet signals.

10. The communication system of claim 1 wherein each said communication device is one of:
a) a ground station capable of both receiving and transmitting data;
b) a satellite capable of both receiving and transmitting data; and
c) a receiver.

11. A method for sending data within a satellite communications system, the method comprising:
receiving a digital data packet at a first ground station within the communications system;
converting the digital data packet into an analog signal;
establishing a magnitude of a selected physical characteristic of the analog packet signal as a function of a destination of the digital data packet;
transmitting the analog packet signal from the first ground station to a first satellite;
routing the analog packet signal to a given transponder aboard the first satellite based on the magnitude of the selected physical characteristic of the analog packet signal; and
transmitting the analog packet signal from the given transponder to a transceiver station.

12. The method of claim 11 wherein the transceiver station is one of:
a) a second satellite; and
b) a ground station having a land-based connection with the digital data packet destination.

13. The method of claim 11 wherein the physical characteristic is selected from the group consisting of: transmission frequency; amplitude; and signal shape.

14. The method of claim 11 further comprising:
identifying a destination Internet Protocol (IP) address of the digital data packet; and wherein the establishing step comprises:
establishing a transmission frequency for the analog packet signal based on the IP address of the digital data packet.

15. The method of claim 14 wherein the step of transmitting the analog packet signal to the satellite comprises:
transmitting the analog packet signal using the established transmission frequency.

16. The method of claim 11 further comprising:
performing the step of routing the analog packet signal aboard the satellite using only analog equipment.

17. The method of claim 11 further comprising:
performing the step of routing the analog packet signal aboard the satellite without demodulating the analog packet signal.

18. The method of claim 11 further comprising:
performing the step of routing the analog packet signal using at least one frequency divider.

19. The method of claim 11 wherein the step of transmitting the analog packet signal to the destination of the digital data packet comprises one of:
transmitting the analog packet signal to a gateway station; and
transmitting the analog packet signal out of a satellite transponder toward a region on the earth including the first ground station, to effect intra-region backhaul.

20. A method, comprising:
providing at least one satellite;
receiving a signal at the satellite from a customer site;
determining a transmission frequency of the customer signal;
routing the customer signal to an output port of a transponder selected according to the determined transmission frequency; and
retransmitting the customer signal from the selected transponder.

21. The method of claim 20 further comprising:
prior to sending the signal to the satellite, determining a destination IP (Internet Protocol) address for the signal; and
assigning a transmission frequency to the signal based on the determined destination IP address.

22. The method of claim 20 wherein the routing step comprises:
deploying a frequency divider having an input and a plurality of outputs, wherein the frequency divider is operable to direct signals within a plurality of frequency ranges along a plurality of respective signal routing paths within the satellite.

23. The method of claim 22 further comprising:
configuring the frequency divider to associate a plurality of transmission frequency ranges with a plurality of signal routing paths emerging from the frequency divider.

24. The method of claim 23 further comprising:
coordinating the association of the transmission frequency ranges with the signal routing paths of the frequency divider with a corresponding association of frequency ranges to data transmission destinations resident within a ground station transmission system.

25. A method comprising:
receiving a data packet at a ground station within a satellite communication system, the data packet including a destination IP (Internet Protocol) address;
identifying the destination IP address of the data packet;
selecting a transmission frequency channel for the data packet based on the IP address of the data packet; and
transmitting the data packet to a satellite, of the satellite communication system, using the selected transmission frequency.

26. The method of claim 25 further comprising:
assigning a plurality of transmission frequencies to a plurality of respective transmission destinations.

27. The method of claim 25 further comprising:
modulating the data packet to provide an analog signal indicative of the data packet, prior to the transmitting step.

28. The method of claim 25 further comprising:
selecting a sub-channel, of the selected channel, for transmission of the data packet based on at least one of:
a) an identification of the ground station from which the data packet is being transmitted; and
b) an identification of a customer site from which the data packet originated.

29. The method of claim 25 further comprising:
receiving the data packet at the satellite;
routing the data packet within the satellite in accordance with the transmission frequency of the data packet; and
transmitting the data packet to a destination transceiver station within the satellite communication system.

30. The method of claim 29 wherein the transceiver station is either a satellite or a ground station.
